(19) United States
(12) Patent Application Publication
(10) Pub. No.: US 2025/0351218 A1
(43) Pub. Date: Nov. 13, 2025

(54) RADIO RESOURCE CONTROL (RRC) STATE SELECTION FOR MULTICAST SERVICE RECEPTION

(71) Applicant: QUALCOMM Incorporated, San Diego, CA (US)

(72) Inventors: Prasad Reddy Kadiri, San Diego, CA (US); Haris Zisimopoulos, London (GB); Miguel Griot, La Jolla, CA (US); Le Liu, San Jose, CA (US); Umesh Phuyal, San Diego, CA (US); Amer Catovic, San Diego, CA (US)

(21) Appl. No.: 18/869,168

(22) PCT Filed: Jun. 13, 2023
(86) PCT No.: PCT/US2023/068348

§ 371 Date: Nov. 25, 2024

(30) Foreign Application Priority Data
Jul. 25, 2022 (GR) 20220100592

(51) Int. Cl. H04W 76/27; H04W 76/40

(52) U.S. Cl. CPC H04W 76/27; H04W 76/40

(57) ABSTRACT

This disclosure provides systems, apparatus, methods, and computer-readable media that support radio resource control (RRC) state selection for multicast service reception. A user equipment (UE) may subscribe to a multicast service while in an RRC connected state and may thereafter transition to an RRC inactive state. Subsequently, a network entity may transmit an indication of whether the UE is to remain in the RRC inactive state to receive a multicast transmission associated with the multicast service or whether the UE is to transition to the RRC connected state to receive the multicast transmission. In some aspects, the indication may enable some UEs may remain in an RRC inactive state to receive a multicast transmission (which may reduce power consumption), while other UEs may transition to an RRC connected state to receive the same multicast transmission (which may increase communication reliability). Other aspects and features are also claimed and described.

### CROSS-REFERENCE TO RELATED APPLICATIONS

This application claims the benefit of Greek patent application No. 20220100592, entitled, “RADIO RESOURCE CONTROL (RRC) STATE SELECTION FOR MULTICAST SERVICE RECEPTION,” filed on Jul. 25, 2022, which is expressly incorporated by reference herein in its entirety.

### TECHNICAL FIELD

Aspects of the present disclosure relate generally to wireless communication systems, and more particularly, to radio resource control (RRC) state selection for multicast service reception in wireless communication systems.

### DESCRIPTION OF THE RELATED TECHNOLOGY

Wireless communications systems are widely deployed to provide various types of communication content such as voice, video, packet data, messaging, broadcast, and so on. A wireless multiple-access communications system may include a number of base stations or network access nodes, each simultaneously supporting communication for multiple communication devices, which may be otherwise known as user equipment (UE). These systems may be capable of supporting communication with multiple UEs by sharing the available system resources (such as time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM).

Some wireless communications systems use multicast services to improve performance. For example, by transmitting the same data to multiple UEs via a multicast transmission, usage of wireless resources may be reduced as compared to individually transmitting the data to the UEs. As a result, availability of wireless resources for other devices or other applications may be increased. However, in some circumstances, a UE may incorrectly receive or decode a multicast transmission. For example, noise or interference that may be present in a wireless communications system may cause the UE to incorrectly receive or decode the multicast transmission. In some circumstances, the UE may request retransmission of the multicast transmission, such as by transmitting a negative acknowledgement (NACK) associated with the multicast transmission to initiate the retransmission. In some other circumstances, the UE may be unable to request the retransmission. For example, in some circumstances, the UE may be unable to access an uplink control channel to transmit the NACK, such as if the UE is in a radio resource control (RRC) inactive state. As a result, if the UE fails to correctly receive or decode the multicast transmission while operating in the RRC inactive state, the UE may be unable to initiate retransmission of the multicast transmission, and as such, the UE may experience reduced communication reliability associated with the multicast service. As such, some wireless communication protocols may ensure or require that UEs are in a connected state to receive a multicast transmission. However, such a technique may be associated with increased power consumption of the UEs, which may be undesirable or infeasible in some applications.

### SUMMARY

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

One innovative aspect of the subject matter described in this disclosure can be implemented in a method for wireless communication performed by a user equipment (UE). The method includes subscribing to a multicast service while operating in a radio resource control (RRC) connected state and transitioning from the RRC connected state to an RRC inactive state. The method further includes receiving, while operating in the RRC inactive state, a paging message associated with the multicast service. The paging message includes an indication of whether the UE is to remain in the RRC inactive state or is to transition from the RRC inactive state to the RRC connected state. The method further includes receiving a multicast transmission associated with the multicast service while operating in one of the RRC inactive state or the RRC connected state. The one of the RRC inactive state or the RRC connected state is based on the indication.

Another innovative aspect of the subject matter described in this disclosure can be implemented in a UE. The UE includes at least one processor and a memory coupled with the at least one processor and storing processor-readable instructions that, when executed by the at least one processor, is configured to subscribe to a multicast service while operating in an RRC connected state and transitioning from the RRC connected state to an RRC inactive state. The at least one processor is further configured to receive, while operating in the RRC inactive state, a paging message associated with the multicast service. The paging message includes an indication of whether the UE is to remain in the RRC inactive state or is to transition from the RRC inactive state to the RRC connected state. The at least one processor is further configured to receive a multicast transmission associated with the multicast service while operating in one of the RRC inactive state or the RRC connected state. The one of the RRC inactive state or the RRC connected state is based on the indication.

Another innovative aspect of the subject matter described in this disclosure can be implemented in a method for wireless communication performed by a base station. The method includes receiving a subscription message associated with a multicast service while a UE operates in an RRC connected state. The method further includes transmitting, while the UE operates in an RRC inactive state, a paging message associated with the multicast service. The paging message includes an indication of whether the UE is to remain in the RRC inactive state or is to transition from the RRC inactive state to the RRC connected state. The method further includes transmitting a multicast transmission associated with the multicast service while the UE operates in one of the RRC inactive state or the RRC connected state. The one of the RRC inactive state or the RRC connected state is based on the indication.

Another innovative aspect of the subject matter described in this disclosure can be implemented in a base station. The base station includes at least one processor and a memory coupled with the at least one processor and storing processor-readable code that, when executed by the at least one processor, is configured to receive a subscription message associated with a multicast service while a UE operates in an RRC connected state. The at least one processor is further configured to transmit, while the UE operates in an RRC inactive state, a paging message associated with the multicast service. The paging message includes an indication of whether the UE is to remain in the RRC inactive state or is to transition from the RRC inactive state to the RRC connected state. The at least one processor is further configured to transmit a multicast transmission associated with the multicast service while the UE operates in one of the RRC inactive state or the RRC connected state. The one of the RRC inactive state or the RRC connected state is based on the indication.

Other aspects, features, and implementations of the present disclosure will become apparent to a person having ordinary skill in the art, upon reviewing the following description of specific, example implementations of the present disclosure in conjunction with the accompanying figures. While features of the present disclosure may be described relative to particular implementations and figures below, all implementations of the present disclosure can include one or more of the advantageous features described herein. In other words, while one or more implementations may be described as having particular advantageous features, one or more of such features may also be used in accordance with the various implementations of the disclosure described herein. In similar fashion, while example implementations may be described below as device, system, or method implementations, such example implementations can be implemented in various devices, systems, and methods.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 is a block diagram illustrating an example wireless communication system that supports radio resource control (RRC) state selection for multicast service reception according to one or more aspects.

FIG. 4 is a flow diagram illustrating an example process that supports RRC state selection for multicast service reception according to one or more aspects.

FIG. 5 is a flow diagram illustrating an example process that supports RRC state selection for multicast service reception according to one or more aspects.

FIG. 6 is a block diagram of an example UE that supports RRC state selection for multicast service reception according to one or more aspects.

FIG. 7 is a block diagram of an example base station that supports RRC state selection for multicast service reception according to one or more aspects.

Like reference numbers and designations in the various drawings indicate like elements.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

The present disclosure provides systems, apparatus, methods, and computer-readable media that support radio resource control (RRC) state selection for multicast service reception. A user equipment (UE) may subscribe to (or “join”) a multicast service while in an RRC connected state. After subscribing to the multicast service, the UE may transition from the RRC connected state to an RRC inactive state.

Subsequently, a network entity may transmit, to the UE, an indication of whether the UE is to remain in the RRC inactive state to receive a multicast transmission associated with the multicast service or whether the UE is to transition to the RRC connected state to receive the multicast transmission. In some examples, the indication may be included in a paging message that notifies UEs subscribed to the multicast service of the multicast transmission. In some examples, the indication may specify that UEs associated with a first priority level are to remain in the RRC inactive state to receive the multicast transmission. Additionally or alternatively, the indication may specify that UEs associated with a second priority level, higher than the first priority level, are to transition to the RRC connected state to receive the multicast transmission. In some such examples, UEs associated with the second priority level may be associated with an ultra-reliable, low-latency communication (URLLC) application type, and UEs associated with the first priority level may be associated with another application type.

Particular implementations of the subject matter described in this disclosure can be implemented to realize one or more of the following potential advantages. In some aspects, by supporting selection of an RRC state for multicast service reception, techniques of the present disclosure may reduce power consumption while increasing communication reliability. For example, some UEs may remain in an RRC inactive state to receive a multicast transmission (which may reduce power consumption), while other UEs may transition to an RRC connected state to receive the same multicast transmission (which may increase communication reliability associated with reception of the multicast transmission). As a result, performance associated with the multicast service may be improved by reducing power consumption for one or more UEs while improving communication reliability for one or more other UEs.

In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably. In some implementations, two or more wireless communications systems, also referred to as wireless communications networks, may be configured to provide or participate in authorized shared access between the two or more wireless communications systems.

A CDMA network may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may implement a radio technology such as Global System for Mobile Communications (GSM). 3GPP defines standards for the GSM EDGE (enhanced data rates for GSM evolution) radio access network (RAN), also denoted as GERAN. GERAN is the radio component of GSM or GSM EDGE, together with the network that joins the base stations (for example, the Ater and Abis interfaces, among other examples) and the base station controllers (for example, A interfaces, among other examples). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may include one or more GERANs, which may be coupled with UTRANs in the case of a UMTS or GSM network. Additionally, an operator network may include one or more LTE networks, or one or more other networks. The various different network types may use different radio access technologies (RATs) and radio access networks (RANs).

An OFDMA network may implement a radio technology such as evolved UTRA (E-UTRA), IEEE 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named the “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP long term evolution (LTE) is a 3GPP project aimed at improving the universal mobile telecommunications system (UMTS) mobile phone standard. The 3GPP may define specifications for the next generation of mobile networks, mobile systems, and mobile devices. The present disclosure may describe certain aspects with reference to LTE, 4G, 5G, or NR technologies; however, the description is not intended to be limited to a specific technology or application, and one or more aspects described with reference to one technology may be understood to be applicable to another technology. Indeed, one or more aspects the present disclosure are related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (such as ˜1 M nodes per km²), ultra-low complexity (such as ˜10 s of bits per see), ultra-low energy (such as ˜10+ years of battery life), and deep coverage with the capability to reach challenging locations; (2) including mission-critical control with strong security to safeguard sensitive personal, financial, or classified information, ultra-high reliability (such as ˜99.9999% reliability), ultra-low latency (such as ˜1 millisecond (ms)), and users with wide ranges of mobility or lack thereof; and (3) with enhanced mobile broadband including extreme high capacity (such as ˜10 Tbps per km²), extreme data rates (such as multi-Gbps rate, 100+ Mbps user experienced rates), and deep awareness with advanced discovery and optimizations.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) or frequency division duplex (FDD) design; and advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHZ, subcarrier spacing may occur with 30 kHz over 80 or 100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

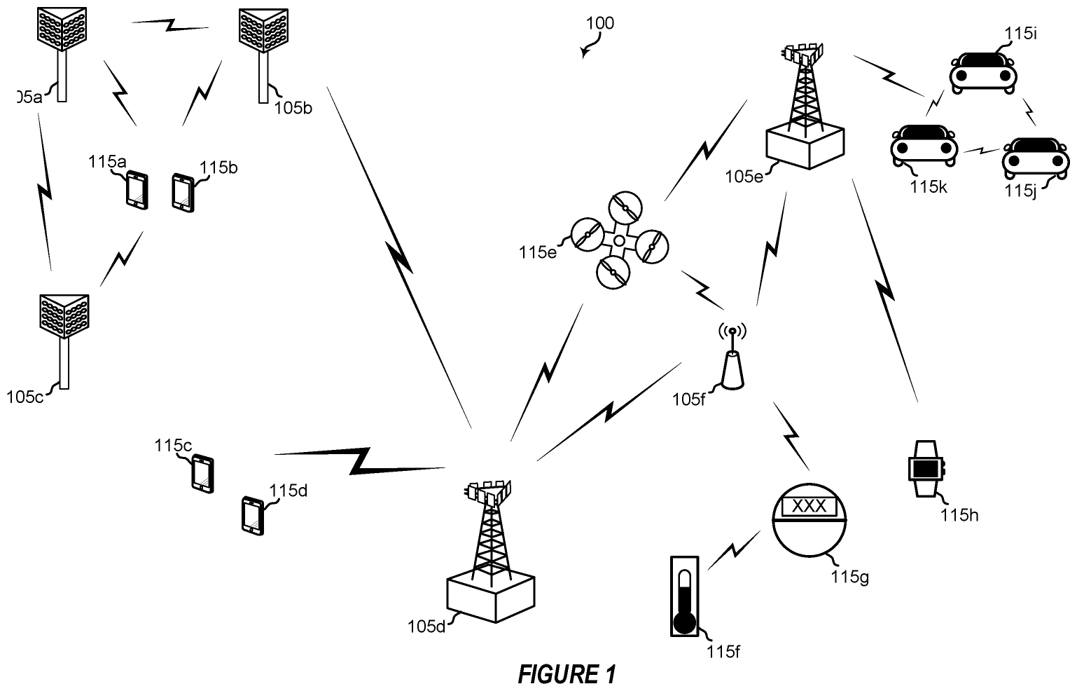

FIG. 1 is a block diagram illustrating details of an example wireless communication system. The wireless communication system may include wireless network 100. The wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements, such as device-to-device, peer-to-peer or ad hoc network arrangements, among other examples.

The wireless network 100 illustrated in FIG. 1 includes a number of base stations 105 and other network entities. A base station may be a station that communicates with the UEs and may be referred to as an evolved node B (eNB), a next generation eNB (gNB), an access point, and the like. Each base station 105 may provide communication coverage for a particular geographic area. In 3GPP, the term “cell” can refer to this particular geographic coverage area of a base station or a base station subsystem serving the coverage area, depending on the context in which the term is used. In implementations of the wireless network 100 herein, the base stations 105 may be associated with a same operator or different operators, such as the wireless network 100 may include a plurality of operator wireless networks. Additionally, in implementations of the wireless network 100 herein, the base stations 105 may provide wireless communications using one or more of the same frequencies, such as one or more frequency bands in licensed spectrum, unlicensed spectrum, or a combination thereof, as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area, such as several kilometers in radius, and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area, such as a home, and, in addition to unrestricted access, may provide restricted access by UEs having an association with the femto cell, such as UEs in a closed subscriber group (CSG), UEs for users in the home, and the like. A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple cells, such as two cells, three cells, four cells, and the like.

The wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

The UEs 115 are dispersed throughout the wireless network 100, and each UE may be stationary or mobile. It should be appreciated that, although a mobile apparatus is commonly referred to as user equipment (UE) in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. Within the present document, a “mobile” apparatus or UE need not necessarily have a capability to move, and may be stationary. Some non-limiting examples of a mobile apparatus, such as may include implementations of one or more of the UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an “Internet of things” (IoT) or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, a gesture tracking device, a medical device, a digital audio player (such as MP3 player), a camera or a game console, among other examples; and digital home or smart home devices such as a home audio, video, and multimedia device, an appliance, a sensor, a vending machine, intelligent lighting, a home security system, or a smart meter, among other examples. In one aspect, a UE may be a device that includes a Universal Integrated Circuit Card (UICC). In another aspect, a UE may be a device that does not include a UICC. In some aspects, UEs that do not include UICCs may be referred to as IoE devices. The UEs 115a-115d of the implementation illustrated in FIG. 1 are examples of mobile smart phone-type devices accessing the wireless network 100. A UE may be a machine specifically configured for connected communication, including machine type communication (MTC), enhanced MTC (eMTC), narrowband IoT (NB-IoT) and the like. The UEs 115e-115k illustrated in FIG. 1 are examples of various machines configured for communication that access 5G network 100.

A mobile apparatus, such as the UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. Backhaul communication between base stations of the wireless network 100 may occur using wired or wireless communication links.

In operation at the 5G network 100, the base stations 105a-105c serve the UEs 115a and 115b using 3D beamforming and coordinated spatial techniques, such as coordinated multipoint (COMP) or multi-connectivity. Macro base station 105d performs backhaul communications with the base stations 105a-105c, as well as small cell, the base station 105f. Macro base station 105d also transmits multicast services which are subscribed to and received by the UEs 115c and 115d. Such multicast services may include mobile television or stream video, or may include other services for providing community information, such as weather emergencies or alerts, such as Amber alerts or gray alerts.

The wireless network 100 of implementations supports mission critical communications with ultra-reliable and redundant links for mission critical devices, such the UE 115e, which is a drone. Redundant communication links with the UE 115e include from the macro base stations 105d and 105e, as well as small cell base station 105f. Other machine type devices, such as UE 115f (thermometer), the UE 115g (smart meter), and the UE 115h (wearable device) may communicate through the wireless network 100 either directly with base stations, such as the small cell base station 105f, and the macro base station 105e, or in multi-hop configurations by communicating with another user device which relays its information to the network, such as the UE 115f communicating temperature measurement information to the smart meter, the UE 115g, which is then reported to the network through the small cell base station 105f. The 5G network 100 may provide additional network efficiency through dynamic, low-latency TDD or FDD communications, such as in a vehicle-to-vehicle (V2V) mesh network between the UEs 115i-115k communicating with the macro base station 105e.

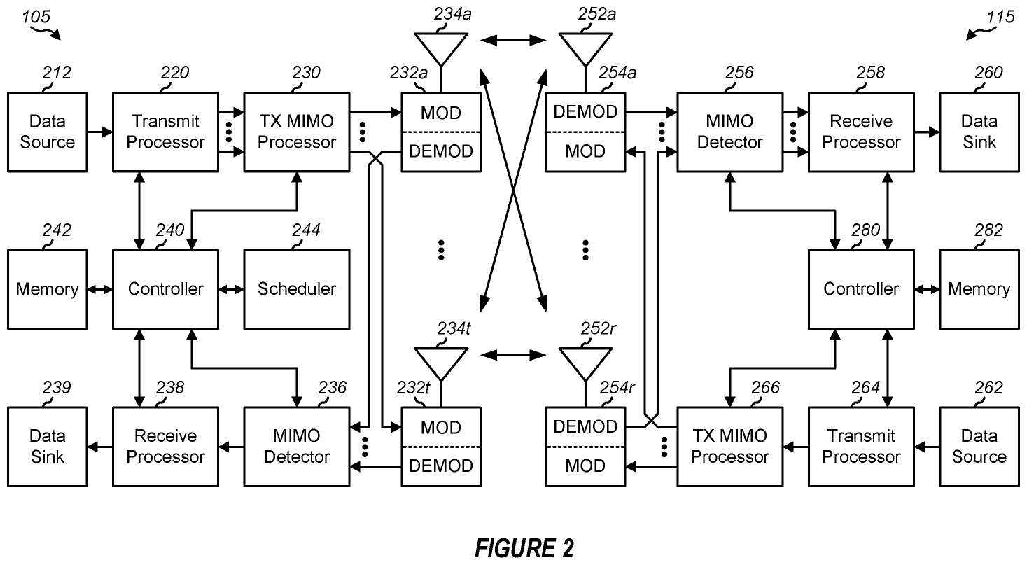

FIG. 2 is a block diagram conceptually illustrating an example design of a base station 105 and a UE 115. The base station 105 and the UE 115 may be one of the base stations and one of the UEs in FIG. 1. For a restricted association scenario (as mentioned above), the base station 105 may be the small cell base station 105f in FIG. 1, and the UE 115 may be the UE 115c or 115d operating in a service area of the base station 105f, which in order to access the small cell base station 105f, would be included in a list of accessible UEs for the small cell base station 105f. Additionally, the base station 105 may be a base station of some other type. As shown in FIG. 2, the base station 105 may be equipped with antennas 234a through 234t, and the UE 115 may be equipped with antennas 252a through 252r for facilitating wireless communications.

At the base station 105, a transmit processor 220 may receive data from a data source 212 and control information from a controller 240. The control information may be for the physical broadcast channel (PBCH), physical control format indicator channel (PCFICH), physical hybrid-ARQ (automatic repeat request) indicator channel (PHICH), physical downlink control channel (PDCCH), enhanced physical downlink control channel (EPDCCH), or MTC physical downlink control channel (MPDCCH), among other examples. The data may be for the PDSCH, among other examples. The transmit processor 220 may process, such as encode and symbol map, the data and control information to obtain data symbols and control symbols, respectively. Additionally, the transmit processor 220 may generate reference symbols, such as for the primary synchronization signal (PSS) and secondary synchronization signal (SSS), and cell-specific reference signal. Transmit (TX) multiple-input multiple-output (MIMO) processor 230 may perform spatial processing on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream, such as for OFDM, among other examples, to obtain an output sample stream. Each modulator 232 may additionally or alternatively process the output sample stream to obtain a downlink signal. For example, to process the output sample stream, each modulator 232 may convert to analog, amplify, filter, and upconvert the output sample stream to obtain the downlink signal. Downlink signals from modulators 232a through 232t may be transmitted via the antennas 234a through 234t, respectively.

At the UE 115, the antennas 252a through 252r may receive the downlink signals from the base station 105 and may provide received signals to the demodulators (DEMODs) 254a through 254r, respectively. Each demodulator 254 may condition a respective received signal to obtain input samples. For example, to condition the respective received signal, each demodulator 254 may filter, amplify, downconvert, and digitize the respective received signal to obtain the input samples. Each demodulator 254 may further process the input samples, such as for OFDM, among other examples, to obtain received symbols. MIMO detector 256 may obtain received symbols from demodulators 254a through 254r, perform MIMO detection on the received symbols if applicable, and provide detected symbols. Receive processor 258 may process the detected symbols, provide decoded data for the UE 115 to a data sink 260, and provide decoded control information to a controller 280. For example, to process the detected symbols, the receive processor 258 may demodulate, deinterleave, and decode the detected symbols.

On the uplink, at the UE 115, a transmit processor 264 may receive and process data (such as for the physical uplink shared channel (PUSCH)) from a data source 262 and control information (such as for the physical uplink control channel (PUCCH)) from the controller 280. Additionally, the transmit processor 264 may generate reference symbols for a reference signal. The symbols from the transmit processor 264 may be precoded by TX MIMO processor 266 if applicable, further processed by the modulators 254a through 254r (such as for SC-FDM, among other examples), and transmitted to the base station 105. At base station 105, the uplink signals from the UE 115 may be received by antennas 234, processed by demodulators 232, detected by MIMO detector 236 if applicable, and further processed by receive processor 238 to obtain decoded data and control information sent by the UE 115. The receive processor 238 may provide the decoded data to data sink 239 and the decoded control information to the controller 240.

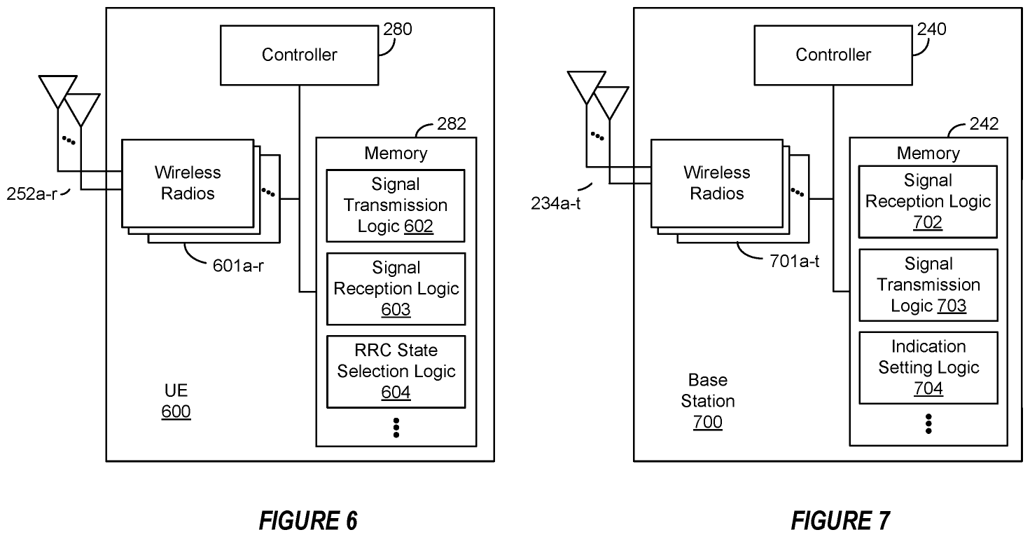

The controllers 240 and 280 may direct the operation at the base station 105 and the UE 115, respectively. The controller 240 or other processors and modules at the base station 105 or the controller 280 or other processors and modules at the UE 115 may perform or direct the execution of various processes for the techniques described herein, such as to perform or direct the execution illustrated in FIGS. 6 and 7, or other processes for the techniques described herein. The memories 242 and 282 may store data and program codes for the base station 105 and The UE 115, respectively. Scheduler 244 may schedule UEs for data transmission on the downlink or uplink.

In some cases, the UE 115 and the base station 105 may operate in a shared radio frequency spectrum band, which may include licensed or unlicensed, such as contention-based, frequency spectrum. In an unlicensed frequency portion of the shared radio frequency spectrum band, the UEs 115 or the base stations 105 may traditionally perform a medium-sensing procedure to contend for access to the frequency spectrum. For example, the UE 115 or base station 105 may perform a listen-before-talk or listen-before-transmitting (LBT) procedure such as a clear channel assessment (CCA) prior to communicating in order to determine whether the shared channel is available. A CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. In some implementations, a CCA may include detection of specific sequences that indicate use of the channel. For example, another device may transmit a specific preamble prior to transmitting a data sequence. In some cases, an LBT procedure may include a wireless node adjusting its own back off window based on the amount of energy detected on a channel or the acknowledge or negative-acknowledge (ACK or NACK) feedback for its own transmitted packets as a proxy for collisions.

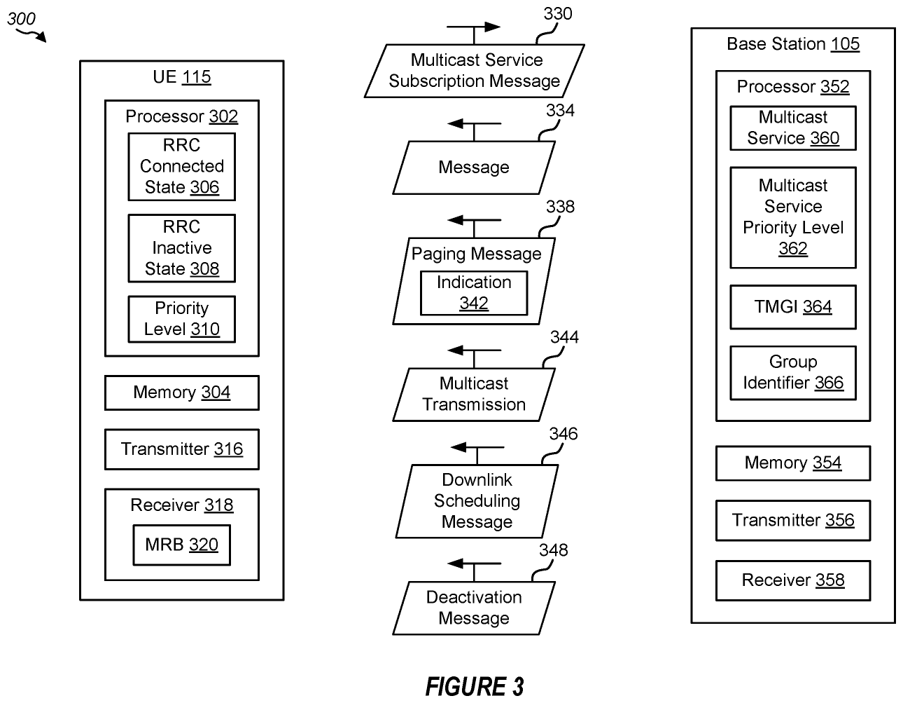

FIG. 3 is a block diagram of an example wireless communications system 300 that supports RRC state selection for multicast service reception according to one or more aspects. In some examples, the wireless communications system 300 may implement aspects of the wireless network 100. The wireless communications system 300 includes the UE 115 and the base station 105. Although one UE 115 and one base station 105 are illustrated, in some other implementations, the wireless communications system 300 may generally include multiple UEs 115, and may include more than one base station 105.

The UE 115 may include a variety of components (such as structural, hardware components) used for carrying out one or more functions described herein. For example, the UE 115 may include one or more processors 302 (hereinafter referred to collectively as “the processor 302”), one or more memory devices 304 (hereinafter referred to collectively as “the memory 304”), one or more transmitters 316 (hereinafter referred to collectively as “the transmitter 316”), and one or more receivers 318 (hereinafter referred to collectively as “the receiver 318”). The processor 302 may be configured to execute instructions stored in the memory 304 to perform one or more operations described herein. In some implementations, the processor 302 includes or corresponds to one or more of the receive processor 258, the transmit processor 264, and the controller 280, and the memory 304 includes or corresponds to the memory 282.

The transmitter 316 is configured to transmit reference signals, control information, and data to one or more other devices, and the receiver 318 is configured to receive references signals, synchronization signals, control information, and data from one or more other devices. For example, the transmitter 316 may transmit signaling, control information, and data to the base station 105, and the receiver 318 may receive signaling, control information, and data from the base station 105. In some implementations, the transmitter 316 and the receiver 318 may be integrated in one or more transceivers. Additionally or alternatively, the transmitter 316 or the receiver 318 may include or correspond to one or more components of the UE 115 described with reference to FIG. 2.

The base station 105 may include a variety of components (such as structural, hardware components) used for carrying out one or more functions described herein. For example, the base station 105 may include one or more processors 352 (hereinafter referred to collectively as “the processor 352”), one or more memory devices 354 (hereinafter referred to collectively as “the memory 354”), one or more transmitters 356 (hereinafter referred to collectively as “the transmitter 356”), and one or more receivers 358 (hereinafter referred to collectively as “the receiver 358”). The processor 352 may be configured to execute instructions stored in the memory 354 to perform one or more operations described herein. In some implementations, the processor 352 includes or corresponds to one or more of the receive processor 238, the transmit processor 220, and the controller 240, and the memory 354 includes or corresponds to the memory 242.

The transmitter 356 is configured to transmit reference signals, synchronization signals, control information, and data to one or more other devices, and the receiver 358 is configured to receive reference signals, control information and data, from one or more other devices. For example, the transmitter 356 may transmit signaling, control information, and data to the UE 115, and the receiver 358 may receive signaling, control information, and data from the UE 115. In some implementations, the transmitter 356 and the receiver 358 may be integrated in one or more transceivers. Additionally or alternatively, the transmitter 356 or the receiver 358 may include or correspond to one or more components of base station 105 described with reference to FIG. 2.

In some implementations, the wireless communications system 300 implements a 5G New Radio (NR) network. For example, the wireless communications system 300 may include multiple 5G-capable UEs 115 and multiple 5G-capable base stations 105, such as UEs and base stations configured to operate in accordance with a 5G NR network protocol such as that defined by the 3GPP.

During operation of the wireless communications system 300, the UE 115 may operate in multiple states. The multiple states may include a radio resource control (RRC) connected state 306 and an RRC inactive state 308. To illustrate, in some implementations, the UE 115 may be associated with an active RRC connection to the base station 105 while operating in the RRC connected state 306, and the UE 115 may be associated with an inactive RRC connection to the base station 105 while operating in the RRC inactive state 308.

The base station 105 may provide a multicast service 360 to one or more UEs, such as the UE 115. In some examples, the base station 105 may provide the multicast service 360 in accordance with a multicast and broadcast services (MBS) protocol, such as a 5G NR MBS protocol. Providing the multicast service 360 may include transmitting multicast data to multiple different UEs 115. In some examples, the multicast service 360 may be to as a multicast station.

To receive messaging (such as multicast data) associated with the multicast service 360, the UE 115 may subscribe to (or “join”) the multicast service 360. Joining the multicast service 360 may also be referred to as subscribing to the multicast service 360. In some examples, subscribing to the multicast service 360 may include transmitting a multicast service subscription message 330 to the base station 105 while operating in the RRC connected state 306. For example, the base station 105 may indicate availability of (or may “advertise”) the multicast service 360, such as by transmitting signaling indicating the availability of the multicast service 360. One or more UEs (such as the UE 115) may subscribe to the multicast service 360 based on the signaling. For example, the UE 115 may transmit the multicast service subscription message 330 to the base station 105 to subscribe to the multicast service 360 based on the signaling.

After subscribing to the multicast service 360, the UE 115 may receive multicast data associated with the multicast service 360. For example, the base station 105 may perform a multicast transmission 344, and a group of one or more UEs including the UE 115 may receive the multicast transmission 344. In some examples, the UE 115 may receive the multicast transmission 344 while operating in the RRC connected state 306. In some other examples, the UE 115 may receive the multicast transmission 344 while operating in the RRC inactive state 308.

In some circumstances, the base station 105 may transmit a message 334 indicating a change from the RRC connected state 306 to the RRC inactive state 308. For example, if the base station 105 determines that no data is available or scheduled to be transmitted to the UE 115, the base station 105 may transmit the message 334 to the UE 115 to initiate the change from the RRC connected state 306 to the RRC inactive state 308, which may reduce power consumption associated with the UE 115.

Based on the message 334, the UE 115 may transition from the RRC connected state 306 to the RRC inactive state 308. To illustrate, in some implementations, transitioning from the RRC connected state 306 to the RRC inactive state 308 may include placing the transmitter 316 in an inactive or low-power mode of operation, such as by powering-down one or more components of the transmitter 316 or by placing the one or more components in a standby mode of operation.

In some circumstances, operation of the UE 115 in the RRC inactive state 308 may reduce multicast reliability for the UE 115, such as due to a lack of uplink feedback from the UE 115 for a multicast radio bearer and due to a lack of subsequent retransmission from the base station 105. To illustrate, in the RRC connected state 306, the UE 115 may have access to an uplink control channel used to transmit feedback to the base station 105 and to initiate a retransmission of data. In the RRC inactive state 308, the UE 115 may not have access to the uplink control channel and may be unable to transmit feedback to the base station to initiate a retransmission of data (such as due to an inactive mode of the transmitter 316). As a result, if the UE 115 fails to correctly receive or decode the multicast transmission 344 while operating in the RRC inactive state 308, the UE 115 may be unable to initiate retransmission of the multicast transmission 344, reducing communication reliability associated with the multicast service 360 for the UE 115. Such communication reliability may be undesirable or infeasible in some implementations, such as in some ultra-reliable, low-latency communication (URLLC) implementations, as an illustrative example.

Some wireless communication protocols may increase communication reliability by ensuring that UEs are in a connected state to receive a multicast transmission. Such a technique may be associated with increased power consumption of the UEs, which may be undesirable or infeasible in some applications, such as a wireless sensor application, as an illustrative example.

To illustrate, in some examples, the UE 115 may receive a paging message 338 from the base station 105 while operating in the RRC inactive state 308. The paging message 338 may indicate that the UE 115 is to transition to the RRC connected state 306 to receive an upcoming transmission, such as the multicast transmission 344. Depending on the example, the paging message 338 may be a group paging message (which may be addressed to the group of UEs subscribed to the multicast service 360) or a unicast paging message that is individually addressed to the UE 115. Further, the paging message 338 may be a core network (CN) paging message or a radio access network (RAN) paging message. The paging message 338 may include an indication of a temporary mobile group identity (TMGI) associated with the multicast service 360.

In some aspects of the disclosure, the UE 115 and the base station 105 may perform operations to enable selection among the RRC connected state 306 and the RRC inactive state 308 for reception of one or more multicast transmissions, such as the multicast transmission 344. To illustrate, in some examples, the paging message 338 may include an indication 342 (such as a triggering indication) associated with selection of one of the RRC inactive state 308 or the RRC connected state 306 for reception of the multicast transmission 344. In some implementations, the indication 342 may include or may be an information element (IE) or UE assistance information that is included in the paging message 338. One or more aspects described herein may enable one or more UEs to operate in the RRC inactive state 308 to receive the multicast transmission 344 (which may reduce power consumption of such UEs) while also enabling one or more other UEs to operate in the RRC connected state 306 to receive the multicast transmission 344 (which may increase communication reliability associated with such UEs).

In some examples, the indication 342 may specify that the UE 115 is to remain in the RRC inactive state 308 to receive the multicast transmission 344 based on a priority level 310 associated with the UE 115. To illustrate, the indication 342 may specify that UEs associated with a first priority level are to remain in the RRC inactive state 308 to receive the multicast transmission 344 and may further specify that UEs associated with a second priority level that is higher than the first priority level are to transition to the RRC connected state 306 to receive the multicast transmission 344. Accordingly, the UE 115 may remain in the RRC inactive state 308 based on the priority level 310 corresponding to the first priority level or may transition to the RRC connected state 306 based on the priority level 310 corresponding to the second priority level. In a non-limiting example, the first priority level may correspond to a low priority level that may be associated with some wireless sensor applications, and the second priority level may correspond to a high priority level that may be associated with some URLLC applications.

The UE 115 may determine the priority level 310 using one or more techniques. In some examples, the UE 115 may determine the priority level 310 during joining of the multicast service 360, such as during a non-access stratum (NAS)-based session joining procedure or during an NAS-based session modification procedure associated with the multicast service 360. In an illustrative example, the UE 115 may determine the priority level 310 using a non-access stratum (NAS) layer associated with the UE 115, such as during joining of the multicast service 360. After receiving the paging message 338, the UE 115 may provide the indication 342 from an RRC layer associated with the UE 115 to the NAS layer. Based on the priority level 310 and further based on the indication 342, the UE 115 may determine, using the NAS layer, whether to remain in the RRC inactive state 308 to receive the multicast transmission 344 or to transition to the RRC connected state 306 to receive the multicast transmission 344.

In some other examples, the indication 342 may directly indicate whether the UE 115 is to remain in the RRC inactive state 308 to if the UE 115 is to transition to the transition to the RRC connected state 306 to receive the multicast transmission 344. In such examples, the indication 342 may be used without the priority level 310 or independently of the priority level 310. In some such examples, a presence of the indication 342 in the paging message 338 may indicate that the UE 115 is to activate a multicast radio bearer (MRB) 320 and to remain in the RRC inactive state 308 to receive the multicast transmission 344 via the MRB 320. An absence of the indication 342 in the paging message 338 may indicate that the UE 115 is to transition to the RRC connected state 306 to receive the multicast transmission 344.

In some other examples, the base station 105 may transmit an indicator of a priority level (such as a multicast service priority level 362) associated with the multicast service 360 to the UE 115 (prior to transmitting the paging message 338). The multicast service priority level 362 may identify that the multicast service 360 is associated with one multiple priorities, such as a first priority level or a second priority level that is higher than the first priority level. Depending on the example, the indicator may correspond to or may be one of an RRC message, a system information block (SIB), or an NAS message, as illustrative examples. The indication 342 may specify that the UE 115 is to transition, based on the multicast service priority level 362, to the RRC connected state 306 to receive the multicast transmission 344. To further illustrate, after receiving the indicator of the multicast service priority level 362, a presence of the indication 342 in the paging message 338 may indicate that the UE 115 is to remain in the RRC inactive state 308 to receive the multicast transmission 344, and an absence of the indication 342 in the paging message 338 may indicate that the UE 115 is to transition to the RRC connected state 306 to receive the multicast transmission 344.

In some other examples, the paging message 338 may be a unicast paging message that may be individually addressed to the UE 115 (such as instead of a group paging message that may be addressed to a group of UEs subscribed to the multicast service 360). In some such examples, the indication 342 may include a UE-specific RAN paging identifier (ID) associated with the UE 115, and the paging message 338 may be an inactive radio network temporary identifier (I-RNTI)-based unicast message sent to high priority UEs to trigger resumption of the RRC connected state 306. To further illustrate, a presence of the indication 342 in the paging message 338 may indicate that the UE 115 is to transition to the RRC connected state 306 to receive the multicast transmission 344. In some such examples, the UE 115 may be a high priority UE. In some other examples, the indication 342 may be associated with the TMGI 364, and a presence of the indication 342 in the paging message 338 may indicate that UEs associated with the TMGI 364 (such as the UE 115) are to remain in the RRC inactive state 308 to receive the multicast transmission 344. In some such examples, a presence of the indication 342 in the paging message 338 may indicate that the UE 115 is to remain in the RRC inactive state 308 to receive the multicast transmission 344, and an absence of the indication 342 in the paging message 338 may indicate that the UE 115 is to transition to the RRC connected state 306 to receive the multicast transmission 344. In some such examples, the UE 115 may be a low priority UE.

In some other examples, UEs subscribed to the multicast service 360 may be assigned to groups, and the base station 105 may select among the RRC connected state 306 and the RRC inactive state 308 for each of the groups. To illustrate, the base station 105 may transmit (such as via NAS signaling or via RRC signaling) to the UE 115 a group identifier 366 associated with the UE 115, such as a high priority group or a low priority group. The paging message 338 may include group information associated with the indication 342. For example, the group information may specify one or more groups for which the indication 342 is applicable. In some such examples, the UE 115 may transition to the RRC connected state 306 based on the group information matching the group identifier 366 associated with the UE 115, or the UE 115 may remain in the RRC inactive state 308 based on the group information differing from the group identifier 366. In some implementations, the paging message 338 may be a group RAN paging message and may indicate a core network ID (such as a 5G short temporary mobile subscriber identity (S-TMSI) and a TMGI or I-RNTI, which may cause one or more UEs associated with the core network ID and the TMGI or I-RNTI to transition to an RRC idle state and to respond to the paging message 338, such as by transmitting an NAS service request or by initiating an RRC connection setup procedure.

In some other examples, the multicast service 360 may be associated with multiple TMGIs, such as a first TMGI and a second TMGI. The first TMGI may be associated with a first group of UEs, such as UEs associated with a first priority level. The second TMGI may be associated with a second group of UEs, such as UEs associated with a second priority level that is higher than the first priority level. The paging message 338 may include one or more of the first TMGI or the second TMGI. A presence of the first TMGI in the paging message 338 may indicate that UEs of the first group are to remain in the RRC inactive state 308 to receive the multicast transmission 344, and a presence of the second TMGI in the paging message 338 may indicate that UEs of the second group are to operate in the RRC connected state 306 to receive the multicast transmission 344. To further illustrate, based on the UE 115 being associated with the first priority level, the UE 115 may remain in the RRC inactive state 308 to receive the multicast transmission 344. Based on the UE 115 being associated with the second priority level, the UE 115 may transition to the RRC connected state 306 to receive the multicast transmission 344.

Alternatively or in addition to supporting RRC state selection for reception of the multicast transmission 344, some aspects of the disclosure support deactivating the multicast service 360 while operating in the RRC inactive state 308. To illustrate, while the UE 115 is operating in the RRC inactive state 308, the base station 105 may transmit a deactivation message 348 to the UE 115. The deactivation message 348 may indicate suspension of radio bearer resources associated with the multicast service 360. The suspension of radio bearer resources may be based on an inactivity associated with the multicast service 360, such as a threshold period of time during which no multicast transmissions of the multicast service 360 are scheduled for performance by the base station 105. The radio bearer resources may be associated with the MRB 320. In some examples, the deactivation message 348 may indicate that the radio bearer resources are released by the base station 105. In some examples, after releasing of the radio bearer resources by the base station 105, the UE 115 may suspend using the radio bearer resources without discarding the radio bearer resources. For example, the UE 115 may retain the radio bearer resources while also ceasing to monitor or receive data using radio bearer resources.

In some examples, the deactivation message 348 may be received in a medium access control (MAC) control element (MAC-CE) that is scheduled by a downlink scheduling message 346 indicating a group radio network temporary identifier (G-RNTI) associated with the multicast service 360. To illustrate, the UE 115 may receive the downlink scheduling message 346 from the base station 105, such as via a PDCCH or PDSCH transmission. The downlink scheduling message 346 may indicate the multicast service 360. For example, bits of the downlink scheduling message 346 may be scrambled with the G-RNTI associated with the multicast service 360.

In some other examples, the downlink scheduling message 346 may include downlink control information (DCI) scheduling bits that are scrambled with the G-RNTI associated with the multicast service 360. The DCI scheduling bits may be PDCCH scheduling bits. By scrambling the DCI scheduling bits with the G-RNTI associated with the multicast service 360, the downlink scheduling message 346 may indicate that the deactivation message 348 is associated with the multicast service 360.

In some other examples, the UE 115 may receive a MRB configuration via a multicast control channel (MCCH) to enable the UE 115 to receive the multicast service 360 while operating in the RRC inactive state 308, and the deactivation message 348 may be indicated by one or more bits of an MCCH change notification associated with the MCCH. The MRB configuration may be associated with the MRB 320, and the UE 115 may use the MCCH to receive transmissions of the multicast service 360, such as the multicast transmission 344. In an example, a bit (such as a first bit) of the one or more bits may indicate that the MCCH change notification is due to the suspension of radio bearer resources. Alternatively or in addition, a bit (such as a second bit different than the first bit) of the one or more bits may indicate that the MCCH change notification is due to a session activation associated with the multicast service 360 or due to an update of a neighbor cell list associated with the multicast service 360. The one or more bits may be indicated by MCCH change notification bits, such as in some implementations in which multiple MCCHs are used. In some other examples, other bits may be used, such as in some implementations in which the same MCCH is used for both broadcast and multicast transmissions.

In some other examples, the deactivation message 348 may be a TMGI-based group paging message that includes a multicast session stop indicator. For example, the deactivation message 348 may be addressed to the group of UEs subscribed to the multicast service 360. The deactivation message 348 may indicate the TMGI 364, and the multicast session stop indicator may indicate that the multicast service 360 is deactivated. The stop indicator may be associated with the TMGI 364.

In some other examples, the deactivation message 348 may be received in a downlink scheduling message (such as the downlink scheduling message 346) that indicates a multicast paging radio network temporary identifier (P-RNTI) associated with the multicast service 360. For example, the downlink scheduling message 346 may include a DCI short indicator field, and one or more bits of the DCI short indicator field may indicate (or represent) the deactivation message 348.

To illustrate, the multicast P-RNTI may be used to scramble cyclic redundancy check (CRC) bits of the downlink scheduling message 346. The P-RNTI may be generated based on the G-RNTI associated with the multicast service 360. In some examples, the downlink scheduling message 346 may be a PDCCH DCI of type 1_0. In some examples, the DCI short indicator field of the downlink scheduling message 346 may have one or more features described with reference to the example of Table 1.

TABLE 1

| Bit Field: | DCI Short Indicator Field: |
|---|---|
| 00 | (Reserved) |
| 01 | Only scheduling information for paging is present in the DCI |
| 10 | Only short message is present in the DCI |
| 11 | Both scheduling information for paging and short message are |
| | present in the DCI |

The example of Table 1 illustrates that bits of the DCI short indicator field may indicate whether a short message is present in the downlink scheduling message 346. If the short message is present in the downlink scheduling message 346 (such as in the case where the bit field has values of “10” or “11”), then the short message may be interpreted according to the Table 2.

TABLE 2

| Bit: | Short Message: |
|---|---|
| 1 | Indication of a BCCH modification |
| 2 | Indication of an emergency |
| | public warning system (EPWS) |
| | notification, secondary EPWS |
| | notification, or commercial mobile |
| | alert system (CMAS) notification |
| 3 | Indication to stop monitoring |
| | PDCCH occasion(s) for paging during |
| | this paging occasion (PO) |
| 4 | Multicast service deactivation alert: |
| | if set to “1”: stop receiving |
| | multicast service in RRC inactive state |
| 5-8 | Configurable |

As shown in the example of Table 2, if the short message is present in the downlink scheduling message 346, the short message may include eight bits (or another number of bits). The bits of the short message may include a multicast service deactivation alert bit. In the example of Table 2, the multicast service deactivation alert bit may correspond to the fourth bit of the short message. In other implementations, the multicast service deactivation alert bit may correspond to another bit of the short message. In the example of Table 2, if the fourth bit is set to “1,” the multicast service deactivation alert bit may indicate to stop receiving multicast service in the RRC inactive state 308, such as by transitioning to the RRC connected state 306 to receive the multicast transmission 344.

As described with reference to FIG. 3, the present disclosure provides techniques for reducing power consumption in the wireless communications system 300 while increasing communication reliability in the wireless communications system 300. For example, some UEs may remain in the RRC inactive state 308 to receive the multicast transmission 344 (which may reduce power consumption), while other UEs may transition to the RRC connected state 306 to receive the multicast transmission 344 (which may increase communication reliability associated with reception of the multicast transmission 344). As a result, performance associated with the multicast service 360 may be improved by reducing power consumption for one or more UEs while improving communication reliability for one or more other UEs.

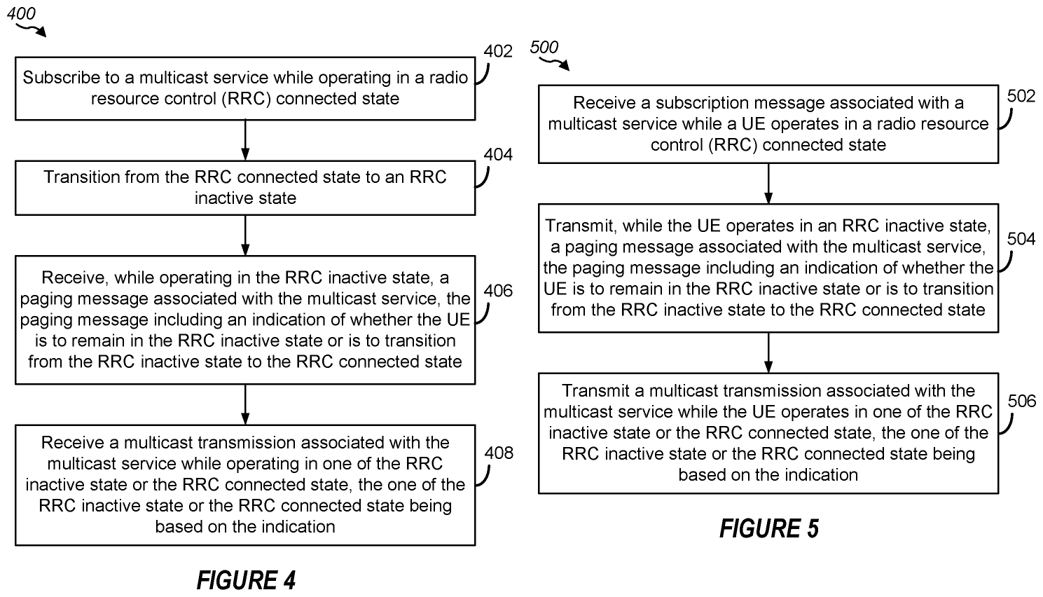

FIG. 4 is a flow diagram illustrating an example process 400 that supports RRC state selection for multicast service reception according to one or more aspects. Operations of the process 400 may be performed by a UE, such as the UE 115 described above with reference to FIGS. 1-3 or a UE as described with reference to FIG. 6. For example, example operations (also referred to as “blocks”) of the process 400 may enable the UE 115 to select the RRC connected state 306 or the RRC inactive state 308 to receive the multicast transmission 344 of FIG. 3.

In block 402, the UE 115 subscribes to a multicast service while operating in an RRC connected state. For example, the UE 115 may subscribe to the multicast service 360 while operating in the RRC connected state 306.

In block 404, the UE 115 transitions from the RRC connected state to an RRC inactive state. For example, the UE 115 may transition from the RRC connected state 306 to the RRC inactive state 308.

In block 406, the UE 115 receives, while operating in the RRC inactive state, a paging message associated with the multicast service. The paging message includes an indication of whether the UE is to remain in the RRC inactive state or is to transition from the RRC inactive state to the RRC connected state. For example, the UE 115 may receive, while operating the RRC inactive state 308, the paging message 338, and the paging message 338 may include the indication 342 of whether the UE 115 is to remain in the RRC inactive state 308 or is to transition from the RRC inactive state 308 to the RRC connected state 306.

In block 408, the UE 115 receives a multicast transmission associated with the multicast service while operating in one of the RRC inactive state or the RRC connected state. The one of the RRC inactive state or the RRC connected state is based on the indication. For example, the UE 115 may receive the multicast transmission 344 while operating in one of the RRC inactive state 308 or the RRC connected state 306. The one of the RRC inactive state 308 or the RRC connected state 306 may be based on the indication 342.

FIG. 5 is a flow diagram illustrating an example process 500 that supports RRC state selection for multicast service reception according to one or more aspects. Operations of the process 500 may be performed by a base station, such as the base station 105 described above with reference to FIGS. 1-3 or a base station as described with reference to FIG. 7. For example, example operations of the process 500 may enable the base station 105 to select the RRC connected state 306 or the RRC inactive state 308 to receive the multicast transmission 344 of FIG. 3.

In block 502, the base station 105 receives a subscription message associated with a multicast service while a UE operates in an RRC connected state. For example, the base station 105 may receive the multicast service subscription message 330 from the UE 115 while the UE 115 operates in the RRC connected state 306.

In block 504, the base station 105 transmits, while the UE operates in an RRC inactive state, a paging message associated with the multicast service. The paging message includes an indication of whether the UE is to remain in the RRC inactive state or is to transition from the RRC inactive state to the RRC connected state. For example, the base station 105 may transmit the paging message 338, and the paging message 338 may include the indication 342 of whether the UE 115 is to remain in the RRC inactive state 308 or is to transition from the RRC inactive state 308 to the RRC connected state 306.

In block 506, the base station 105 transmits a multicast transmission associated with the multicast service while the UE operates in one of the RRC inactive state or the RRC connected state. The one of the RRC inactive state or the RRC connected state is based on the indication. For example, the base station 105 may perform the multicast transmission 344 while the UE 115 operates in one of the RRC inactive state 308 or the RRC connected state 306. The one of the RRC inactive state 308 or the RRC connected state 306 may be based on the indication 342.

FIG. 6 is a block diagram of an example UE 600 that supports RRC state selection for multicast service reception according to one or more aspects. The UE 600 may be configured to perform operations, including the blocks of the process 400 described with reference to FIG. 4. In some implementations, the UE 600 includes the structure, hardware, and components shown and described with reference to the UE 115 of FIG. 2 or 3. For example, the UE 600 includes the controller 280, which operates to execute logic or computer instructions stored in the memory 282, as well as controlling the components of the UE 600 that provide the features and functionality of the UE 600. The UE 600, under control of the controller 280, transmits and receives signals via wireless radios 601a-r and the antennas 252a-r. The wireless radios 601a-r include various components and hardware, as illustrated in FIG. 2 for the UE 115, including the modulator and demodulators 254a-r, the MIMO detector 256, the receive processor 258, the transmit processor 264, and the TX MIMO processor 266.

As shown, the memory 282 may include signal transmission logic 602, signal reception logic 603, and RRC state selection logic 604. The controller 280 may execute the signal transmission logic 602 to transmit one or more signals, such as the multicast service subscription message 330. The controller 280 may execute the signal reception logic 603 to receive one or more signals, such as the paging message 338 and the multicast transmission 344. The controller 280 may execute the RRC state selection logic 604 to select among the RRC connected state 306 and the RRC inactive state 308, such as based on the indication 342. The UE 600 may receive signals from or transmit signals to one or more network entities, such as the base station 105 of FIGS. 1-3 or a base station as illustrated in FIG. 7.

In some implementations, the UE 600 may be configured to perform the process 400 of FIG. 4. To illustrate, the UE 600 may execute, under control of the controller 280, the signal transmission logic 602, the signal reception logic 603, and the RRC state selection logic 604 stored in the memory 282. The execution environment of the signal transmission logic 602 provides the functionality to perform at least the operations in block 402. The execution environment of the signal reception logic 603 provides the functionality to perform at least the operations in block 406 and 408. The execution environment of the RRC state selection logic 604 provides the functionality to perform at least the operations in block 404 and to select an RRC state based on the indication 342.

FIG. 7 is a block diagram of an example base station 700 that supports RRC state selection for multicast service reception according to one or more aspects. The base station 700 may be configured to perform operations, including the blocks of the process 500 described with reference to FIG. 5. In some implementations, the base station 700 includes the structure, hardware, and components shown and described with reference to the base station 105 of FIGS. 1-3. For example, the base station 700 may include the controller 240, which operates to execute logic or computer instructions stored in the memory 242, as well as controlling the components of the base station 700 that provide the features and functionality of the base station 700. The base station 700, under control of the controller 240, transmits and receives signals via wireless radios 701a-t and the antennas 234a-t. The wireless radios 701a-t include various components and hardware, as illustrated in FIG. 2 for the base station 105, including the modulator and demodulators 232a-t, the transmit processor 220, the TX MIMO processor 230, the MIMO detector 236, and the receive processor 238.

As shown, the memory 242 may include signal reception logic 702, signal transmission logic 703, and indication setting logic 704. The controller 240 may execute the signal reception logic 702 to receive one or more signals, such as the multicast service subscription message 330. The controller 240 may execute the signal transmission logic 703 to transmit one or more signals, such as the paging message 338 and the multicast transmission 344. The controller 240 may execute the indication setting logic 704 to set the indication 342, such as to indicate one of the RRC connected state 306 or the RRC inactive state 308. The base station 700 may receive signals from or transmit signals to one or more UEs, such as the UE 115 of FIGS. 1-3 or the UE 600 of FIG. 6.

In some implementations, the base station 700 may be configured to perform the process 500 of FIG. 5. To illustrate, the base station 700 may execute, under control of the controller 240, the signal reception logic 702, the signal transmission logic 703, and the indication setting logic 704 stored in the memory 242. The execution environment of the signal reception logic 702 provides the functionality to perform at least the operations in block 502. The execution environment of the signal transmission logic 703 provides the functionality to perform at least the operations in block 504 and block 506. The execution environment of the indication setting logic 704 provides the functionality to set the indication 342, such as to indicate one of the RRC connected state 306 or the RRC inactive state 308.

In a first aspect, a method for wireless communication performed by a UE includes subscribing to a multicast service while operating in a radio resource control (RRC) connected state and transitioning from the RRC connected state to an RRC inactive state. The method further includes receiving, while operating in the RRC inactive state, a paging message associated with the multicast service. The paging message includes an indication of whether the UE is to remain in the RRC inactive state or is to transition from the RRC inactive state to the RRC connected state. The method further includes receiving a multicast transmission associated with the multicast service while operating in one of the RRC inactive state or the RRC connected state. The one of the RRC inactive state or the RRC connected state is based on the indication.

In a second aspect, in combination with the first aspect, the indication specifies that the UE is to remain in the RRC inactive state to receive the multicast transmission based on a priority level associated with the UE.

In a third aspect, in combination with one or more of the first aspect or second aspect, a presence of the indication in the paging message indicates that the UE is to activate an MRB and to remain in the RRC inactive state to receive the multicast transmission.

In a fourth aspect, in combination with one or more of the first aspect through third aspect, the method includes receiving an indicator of a priority level associated with the multicast service, and the indication specifies that the UE is to transition, based on the priority level, to the RRC connected state to receive the multicast transmission.

In a fifth aspect, in combination with one or more of the first aspect through fourth aspect, the paging message is a unicast paging message, the indication includes a UE-specific RAN paging ID associated with the UE, and a presence of the indication in the paging message indicates that the UE is to transition to the RRC connected state to receive the multicast transmission.

In a sixth aspect, in combination with one or more of the first aspect through fifth aspect, the indication is associated with a TMGI, and a presence of the indication in the paging message indicates that UEs associated with the TMGI are to remain in the RRC inactive state to receive the multicast transmission.

In a seventh aspect, in combination with one or more of the first aspect through the sixth aspect, the method includes receiving a group identifier associated with the UE, and the paging message includes group information associated with the indication.

In an eighth aspect, in combination with one or more of the first through the seventh aspect, the paging message includes one or more of a first TMGI associated with a first priority level or a second TMGI associated with a second priority level that is higher than the first priority level.

In a ninth aspect, a UE includes at least one processor and a memory coupled with the at least one processor and storing processor-readable instructions that, when executed by the at least one processor, is configured to subscribe to a multicast service while operating in an RRC connected state and transitioning from the RRC connected state to an RRC inactive state. The at least one processor is further configured to receive, while operating in the RRC inactive state, a paging message associated with the multicast service. The paging message includes an indication of whether the UE is to remain in the RRC inactive state or is to transition from the RRC inactive state to the RRC connected state. The at least one processor is further configured to receive a multicast transmission associated with the multicast service while operating in one of the RRC inactive state or the RRC connected state. The one of the RRC inactive state or the RRC connected state is based on the indication.

In a tenth aspect, in combination with the ninth aspect, the indication specifies that the UE is to remain in the RRC inactive state to receive the multicast transmission based on a priority level associated with the UE.

In an eleventh aspect, in combination with one or more of the ninth through the tenth aspect, a presence of the indication in the paging message indicates that the UE is to activate an MRB and to remain in the RRC inactive state to receive the multicast transmission.

In a twelfth aspect, in combination with one or more of the ninth through the eleventh aspect, the at least one processor is further configured to receive an indicator of a priority level associated with the multicast service, and the indication specifies that the UE is to transition, based on the priority level, to the RRC connected state to receive the multicast transmission.

In a thirteenth aspect, in combination with one or more of the ninth through the twelfth aspect, the paging message is a unicast paging message, the indication includes a UE-specific RAN paging ID associated with the UE, and a presence of the indication in the paging message indicates that the UE is to transition to the RRC connected state to receive the multicast transmission.

In a fourteenth aspect, in combination with one or more of the ninth through the thirteenth aspect, indication is associated with a TMGI, and a presence of the indication in the paging message indicates that UEs associated with the TMGI are to remain in the RRC inactive state to receive the multicast transmission.

In a fifteenth aspect, in combination with one or more of the ninth through the fourteenth aspect, the at least one processor is further configured to receive a group identifier associated with the UE, and the paging message includes group information associated with the indication.

In a sixteenth aspect, in combination with one or more of the ninth through the fifteenth aspect, the paging message includes one or more of a first TMGI associated with a first priority level or a second TMGI associated with a second priority level that is higher than the first priority level.

In a seventeenth aspect, a method for wireless communication performed by a base station includes receiving a subscription message associated with a multicast service while a UE operates in an RRC connected state. The method further includes transmitting, while the UE operates in an RRC inactive state, a paging message associated with the multicast service. The paging message includes an indication of whether the UE is to remain in the RRC inactive state or is to transition from the RRC inactive state to the RRC connected state. The method further includes transmitting a multicast transmission associated with the multicast service while the UE operates in one of the RRC inactive state or the RRC connected state. The one of the RRC inactive state or the RRC connected state is based on the indication.

In an eighteenth aspect, in combination with the seventeenth aspect, the indication specifies that the UE is to remain in the RRC inactive state to receive the multicast transmission based on a priority level associated with the UE.

In a nineteenth aspect, in combination with one or more of the seventeenth aspect or the eighteenth aspect, a presence of the indication in the paging message indicates that the UE is to activate an MRB and to remain in the RRC inactive state to receive the multicast transmission.

In a twentieth aspect, in combination with one or more of the seventeenth aspect through the nineteenth aspect, the method includes transmitting an indicator of a priority level associated with the multicast service, and the indication specifies that the UE is to transition, based on the priority level, to the RRC connected state to receive the multicast transmission.

In a twenty-first aspect, in combination with one or more of the seventeenth aspect through the twentieth aspect, the paging message is a unicast paging message, the indication includes a UE-specific RAN paging ID associated with the UE, and a presence of the indication in the paging message indicates that the UE is to transition to the RRC connected state to receive the multicast transmission.

In a twenty-second aspect, in combination with one or more of the seventeenth aspect through the twenty-first aspect, the method includes transmitting a group identifier associated with the UE, and the paging message includes group information associated with the indication.

In a twenty-third aspect, in combination with one or more of the seventeenth aspect through the twenty-second aspect, the paging message includes one or more of a first TMGI associated with a first priority level or a second TMGI associated with a second priority level that is higher than the first priority level.

In a twenty-fourth aspect, a base station includes at least one processor and a memory coupled with the at least one processor and storing processor-readable code that, when executed by the at least one processor, is configured to receive a subscription message associated with a multicast service while a UE operates in an RRC connected state. The at least one processor is further configured to transmit, while the UE operates in an RRC inactive state, a paging message associated with the multicast service. The paging message includes an indication of whether the UE is to remain in the RRC inactive state or is to transition from the RRC inactive state to the RRC connected state. The at least one processor is further configured to transmit a multicast transmission associated with the multicast service while the UE operates in one of the RRC inactive state or the RRC connected state. The one of the RRC inactive state or the RRC connected state is based on the indication.

In a twenty-fifth aspect, in combination with the twenty-fourth aspect, the indication specifies that the UE is to remain in the RRC inactive state to receive the multicast transmission based on a priority level associated with the UE.

In a twenty-sixth aspect, in combination with one or more of the twenty-fourth aspect through the twenty-fifth aspect, a presence of the indication in the paging message indicates that the UE is to activate an MRB and to remain in the RRC inactive state to receive the multicast transmission.

In a twenty-seventh aspect, in combination with one or more of the twenty-fourth aspect through the twenty-sixth aspect, the at least one processor is further configured to transmit an indicator of a priority level associated with the multicast service, and the indication specifies that the UE is to transition, based on the priority level, to the RRC connected state to receive the multicast transmission.

In a twenty-eighth aspect, in combination with one or more of the twenty-fourth aspect through the twenty-seventh aspect, the indication is associated with a TMGI, and a presence of the indication in the paging message indicates that UEs associated with the TMGI are to remain in the RRC inactive state to receive the multicast transmission.

In a twenty-ninth aspect, in combination with one or more of the twenty-fourth aspect through the twenty-eighth aspect, the at least one processor is further configured to transmit a group identifier associated with the UE, and the paging message includes group information associated with the indication.

In a thirtieth aspect, in combination with one or more of the twenty-fourth aspect through the twenty-ninth aspect, the paging message includes one or more of a first TMGI associated with a first priority level or a second TMGI associated with a second priority level that is higher than the first priority level.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

One or more components, functional blocks, and modules described herein with respect to FIGS. 1-7 may include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, some other implementations are within the scope of the following claims. In some cases, the actions recited in the claims can be performed in a different order and still achieve desirable results.

As used herein, including in the claims, the term “or,” when used in a list of two or more items, means that any one of the listed items can be employed by itself, or any combination of two or more of the listed items can be employed. For example, if a composition is described as containing components A, B, or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for wireless communication performed by a user equipment (UE), the method comprising:
subscribing to a multicast service while operating in a radio resource control (RRC) connected state;
transitioning from the RRC connected state to an RRC inactive state;
receiving, while operating in the RRC inactive state, a paging message associated with the multicast service, the paging message including an indication of whether the UE is to remain in the RRC inactive state or is to transition from the RRC inactive state to the RRC connected state; and
receiving a multicast transmission associated with the multicast service while operating in one of the RRC inactive state or the RRC connected state, the one of the RRC inactive state or the RRC connected state being based on the indication.

2. The method of claim 1, wherein the indication specifies that the UE is to remain in the RRC inactive state to receive the multicast transmission based on a priority level associated with the UE.

3. The method of claim 1, wherein a presence of the indication in the paging message indicates that the UE is to activate a multicast radio bearer (MRB) and to remain in the RRC inactive state to receive the multicast transmission.

4. The method of claim 1, further comprising receiving an indicator of a priority level associated with the multicast service, wherein the indication specifies that the UE is to transition, based on the priority level, to the RRC connected state to receive the multicast transmission.

5. The method of claim 1, wherein the paging message is a unicast paging message, wherein the indication includes a UE-specific radio access network (RAN) paging identifier (ID) associated with the UE, and wherein a presence of the indication in the paging message indicates that the UE is to transition to the RRC connected state to receive the multicast transmission.

6. The method of claim 1, wherein the indication is associated with a temporary mobile group identity (TMGI), and wherein a presence of the indication in the paging message indicates that UEs associated with the TMGI are to remain in the RRC inactive state to receive the multicast transmission.

7. The method of claim 1, further comprising receiving a group identifier associated with the UE, and wherein the paging message includes group information associated with the indication.

8. The method of claim 1, wherein the paging message includes one or more of a first temporary mobile group identity (TMGI) associated with a first priority level or a second TMGI associated with a second priority level that is higher than the first priority level.

9. A user equipment (UE) comprising:
at least one processor; and
a memory coupled with the at least one processor and storing processor-readable code that, when executed by the at least one processor, is configured to:
subscribe to a multicast service while operating in a radio resource control (RRC) connected state;
transition from the RRC connected state to an RRC inactive state;
receive, while operating in the RRC inactive state, a paging message associated with the multicast service, the paging message including an indication of whether the UE is to remain in the RRC inactive state or is to transition from the RRC inactive state to the RRC connected state; and
receive a multicast transmission associated with the multicast service while operating in one of the RRC inactive state or the RRC connected state, the one of the RRC inactive state or the RRC connected state being based on the indication.

10. The UE of claim 9, wherein the indication specifies that the UE is to remain in the RRC inactive state to receive the multicast transmission based on a priority level associated with the UE.

11. The UE of claim 9, wherein a presence of the indication in the paging message indicates that the UE is to activate a multicast radio bearer (MRB) and to remain in the RRC inactive state to receive the multicast transmission.

12. The UE of claim 9, wherein the at least one processor is further configured to receive an indicator of a priority level associated with the multicast service, and wherein the indication specifies that the UE is to transition, based on the priority level, to the RRC connected state to receive the multicast transmission.

13. The UE of claim 9, wherein the paging message is a unicast paging message, wherein the indication includes a UE-specific radio access network (RAN) paging identifier (ID) associated with the UE, and wherein a presence of the indication in the paging message indicates that the UE is to transition to the RRC connected state to receive the multicast transmission.

14. The UE of claim 9, wherein the indication is associated with a temporary mobile group identity (TMGI), and wherein a presence of the indication in the paging message indicates that UEs associated with the TMGI are to remain in the RRC inactive state to receive the multicast transmission.

15. The UE of claim 9, wherein the at least one processor is further configured to receive a group identifier associated with the UE, and wherein the paging message includes group information associated with the indication.

16. The UE of claim 9, wherein the paging message includes one or more of a first temporary mobile group identity (TMGI) associated with a first priority level or a second TMGI associated with a second priority level that is higher than the first priority level.

17. A method for wireless communication performed by a base station, the method comprising:
receiving a subscription message associated with a multicast service while a user equipment (UE) operates in a radio resource control (RRC) connected state;
transmitting, while the UE operates in an RRC inactive state, a paging message associated with the multicast service, the paging message including an indication of whether the UE is to remain in the RRC inactive state or is to transition from the RRC inactive state to the RRC connected state; and
transmitting a multicast transmission associated with the multicast service while the UE operates in one of the RRC inactive state or the RRC connected state, the one of the RRC inactive state or the RRC connected state being based on the indication.

18. The method of claim 17, wherein the indication specifies that the UE is to remain in the RRC inactive state to receive the multicast transmission based on a priority level associated with the UE.

19. The method of claim 17, wherein a presence of the indication in the paging message indicates that the UE is to activate a multicast radio bearer (MRB) and to remain in the RRC inactive state to receive the multicast transmission.

20. The method of claim 17, further comprising transmitting an indicator of a priority level associated with the multicast service, wherein the indication specifies that the UE is to transition, based on the priority level, to the RRC connected state to receive the multicast transmission.

21. The method of claim 17, wherein the paging message is a unicast paging message, wherein the indication includes a UE-specific radio access network (RAN) paging identifier (ID) associated with the UE, and wherein a presence of the indication in the paging message indicates that the UE is to transition to the RRC connected state to receive the multicast transmission.

22. The method of claim 17, further comprising transmitting a group identifier associated with the UE, and wherein the paging message includes group information associated with the indication.

23. The method of claim 17, wherein the paging message includes one or more of a first temporary mobile group identity (TMGI) associated with a first priority level or a second TMGI associated with a second priority level that is higher than the first priority level.

24. A base station comprising:
at least one processor; and
a memory coupled with the at least one processor and storing processor-readable code that, when executed by the at least one processor, is configured to:
receive a subscription message associated with a multicast service while a UE operates in a radio resource control (RRC) connected state;
transmit, while the UE operates in an RRC inactive state, a paging message associated with the multicast service, the paging message including an indication of whether the UE is to remain in the RRC inactive state or is to transition from the RRC inactive state to the RRC connected state; and
transmit a multicast transmission associated with the multicast service while the UE operates in one of the RRC inactive state or the RRC connected state, the one of the RRC inactive state or the RRC connected state being based on the indication.

25. The base station of claim 24, wherein the indication specifies that the UE is to remain in the RRC inactive state to receive the multicast transmission based on a priority level associated with the UE.

26. The base station of claim 24, wherein a presence of the indication in the paging message indicates that the UE is to activate a multicast radio bearer (MRB) and to remain in the RRC inactive state to receive the multicast transmission.

27. The base station of claim 24, wherein the at least one processor is further configured to transmit an indicator of a priority level associated with the multicast service, and wherein the indication specifies that the UE is to transition, based on the priority level, to the RRC connected state to receive the multicast transmission.

28. The base station of claim 24, wherein the indication is associated with a temporary mobile group identity (TMGI), and wherein a presence of the indication in the paging message indicates that UEs associated with the TMGI are to remain in the RRC inactive state to receive the multicast transmission.

29. The base station of claim 24, wherein the at least one processor is further configured to transmit a group identifier associated with the UE, and wherein the paging message includes group information associated with the indication.

30. The base station of claim 24, wherein the paging message includes one or more of a first temporary mobile group identity (TMGI) associated with a first priority level or a second TMGI associated with a second priority level that is higher than the first priority level.
